(19) United States
(12) Patent Application Publication
(10) Pub. No.: US 2005/0081053 A1
(43) Pub. Date: Apr. 14, 2005

(54) Systems and methods for efficient computer virus detection

(75) Inventors: James Edward Aston, Morrisville, NC (US); John Michael Lake, Cary, NC (US); Durga Devi Mannaru, Raleigh, NC (US)

Correspondence Address: David R. Irvin;IBM Corporation T81/503, PO Box 12195, Research Triangle Park, NC, 27709, US

(73) Assignee: International Business Machines Corlporation, Armonk, NY (US)

(21) Appl. No.: 10/683,665

(22) Filed: Oct. 10, 2003

(51) Int. Cl. G06F 11/30

(52) U.S. Cl. 713/200

(57) ABSTRACT

A technique is provided to organize different virus signatures into anti-virus sets to minimize the impact on processor utilization due to the scanning of computer viruses. All of the virus signatures assigned to an anti-virus set share a common characteristic. The defined anti-virus sets are then associated with an executing agent so that whenever the executing agent's target file is accessed, the target file is scanned with virus signatures stored in the previously assigned anti-virus set to determine if the target file is contaminated with a virus.

### FIELD OF THE INVENTION

The present invention relates generally to improved systems and methods for detecting computer viruses, and, more particularly, to advantageous techniques for providing automatic and user selectable mechanisms for organizing anti-virus sets containing virus signatures to software applications to minimize the impact on processor utilization due to the scanning of computer viruses.

### BACKGROUND OF THE INVENTION

Typically, today's computer anti-virus software programs spend a considerable amount of time checking computer files against virus signatures which have become outdated. Computer viruses typically exploit exposures in operating systems such as AIX®, LINUX®, Windows®, or the like and interpreters such as Java™ Virtual Machine, Visual Basic, or the like. Viruses also exploit exposures found in off the shelf software applications such as Microsoft® Outlook®, Microsoft® Excel, or the like. However, over time, new versions of operating systems, interpreters, and software applications address those previous exposures rendering many of the virus signatures irrelevant.

Furthermore, many of the 50,000 viruses in existence are directed towards exposures in the Windows® operating system or versions of popular software applications tailored to run on Windows®. Although the Windows® operating system may be rather popular, many corporations run versions of popular software applications on computers running other operating systems as well. These corporations are typically required to run anti-virus software programs on their computers for security purposes. Many of these typical anti-virus programs which run on non-Windows® operating systems continue to scan files against virus signatures tailored to versions of software applications to run on Windows®. When irrelevant signatures are applied against files, computer resources such as processor utilization, memory, storage, and the like are needlessly expended. It should be noted the term Windows® as used herein refers to the family of Windows® operating systems including XP, XP Professional, NT, and the like, developed by Microsoft® Corporation.

Clearly, checking 50,000 virus signatures against every new file when many of the signatures are irrelevant and depend upon the environment in which the anti-virus program is employed results in inefficient use of computer resources. A need exists for systems and methods of providing a more efficient detection of computer viruses.

### SUMMARY OF THE INVENTION

Among its several aspects, the present invention provides a mechanism for organizing virus signatures into anti-virus sets where each set contains a characteristic shared by all the virus signatures within the set. Upon program start of an executing agent, an anti-virus program in connection with the associated anti-virus set containing the virus signatures for this executable verifies the integrity of the executable. By leveraging the association of specific executing agents with anti-virus sets, a real-time anti-virus program advantageously utilizes the computer resources by focusing virus detectors on viruses tailored to the operating environment.

Another aspect of the present invention includes providing a table modifiable by a user to further specify the scope and level of scanning a virus carrier with virus signatures.

Another aspect of the present invention includes providing the assignment of rules to an executable to control the manner in which the anti-virus set applies to the executable's target files.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a block diagram of an exemplary computer system in which the present invention may be suitably implemented;

FIG. 2 is a block diagram illustrating the functional software components of a specific example of a computer system in accordance with a preferred embodiment of the present invention;

FIG. 3 shows an exemplary database relationship diagram for partitioning virus signatures in accordance with the present invention; and

FIG. 4 is a flowchart illustrating a method of detecting computer viruses in accordance with the present invention.

### DETAILED DESCRIPTION

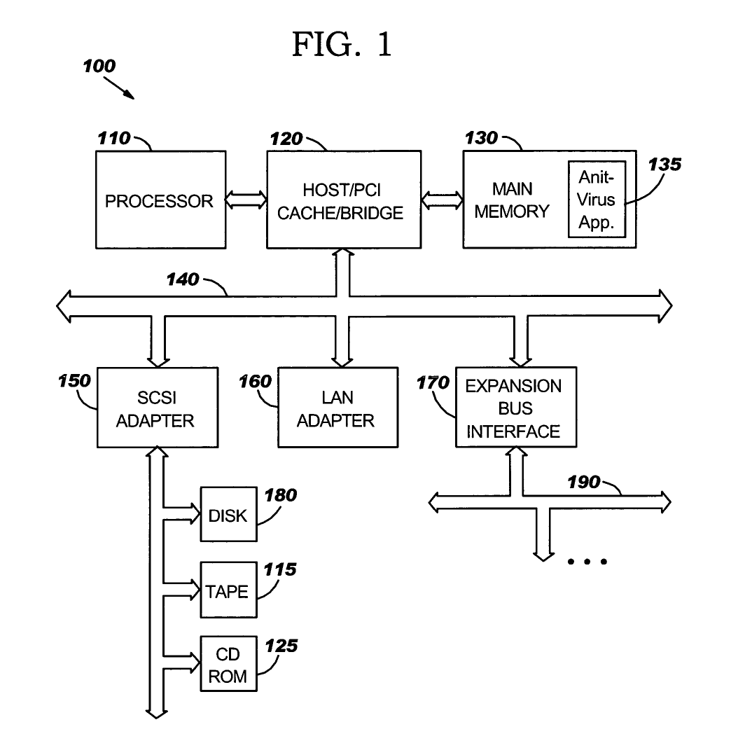

FIG. 1 shows a block diagram illustrating a computer in which the present invention may be suitably implemented. A computer 100 may suitably be a handheld computer, notebook, server or any other processor based machine requiring protection from a computer virus. The computer as illustrated employs a peripheral component interconnect (PCI) local bus architecture. Although a PCI bus is shown, other bus architectures such as Accelerated Graphics Port (AGP) and Industry Standard Architecture (ISA) may be used. A processor 110 and main memory 130 are connected to PCI local bus 140 through PCI bridge 120. PCI bridge 120 also may include an integrated memory controller and cache memory for processor 110. In the depicted example, a small computer system interface (SCSI) host bus adapter 150, a local area network (LAN) adapter 160, and an expansion bus interface 170 are connected to the PCI local bus 140 by direct component connection. Expansion bus interface 170 provides a connection to an expansion bus 190 for additional peripherals not shown. The SCSI host bus adapter 150 provides a connection for hard disk drive 180, a tape drive 115, and a CD-ROM drive 125. An operating system runs on processor 110 and is used to coordinate and provide control of various components within the computer 100. The operating system may be a commercially available operating system, such as AIX®, LINUX®T, Windows®, Windows® CE 3.0, or the like. An object oriented programming system such as Java™, Object Oriented Perl, or Visual Basic may run in conjunction with the operating system and provide calls to the operating system from Java™ programs or applications executed by the processor 110 in the computer 100. Instructions for the operating system, the object-oriented operating system, and applications or programs such as the present invention are located on storage devices, such as disk 180 or a network server, and may be loaded into main memory 130 for execution by processor 110. Anti-virus application 135 contains instructions to perform in accordance with the present invention as illustrated in the embodiment of FIG. 1. The instructions perform steps such as organizing virus signatures into a plurality of anti-virus sets where each set contains a characteristic shared by all the virus signatures within the set, associating a portion of the plurality of anti-virus sets with the executing agent, and, in response to a trigger mechanism caused by the executing agent scanning the contents of the target file for a virus signature which matches a virus signature stored in the associated one or more anti-virus sets. The processor 110 may typically run at 200 Mhz or greater.

Those of ordinary skill in the art will appreciate that the hardware in FIG. 1 may vary depending on the implementation. Other internal hardware or peripheral devices, such as flash ROM or equivalent nonvolatile memory, and the like, may be used in addition to or in place of the hardware depicted in FIG. 1. Also, the processes of the present invention may be applied to a multiprocessor data processing system.

The depicted example in FIG. 1 and described examples below are not meant to imply architectural limitations of the present invention.

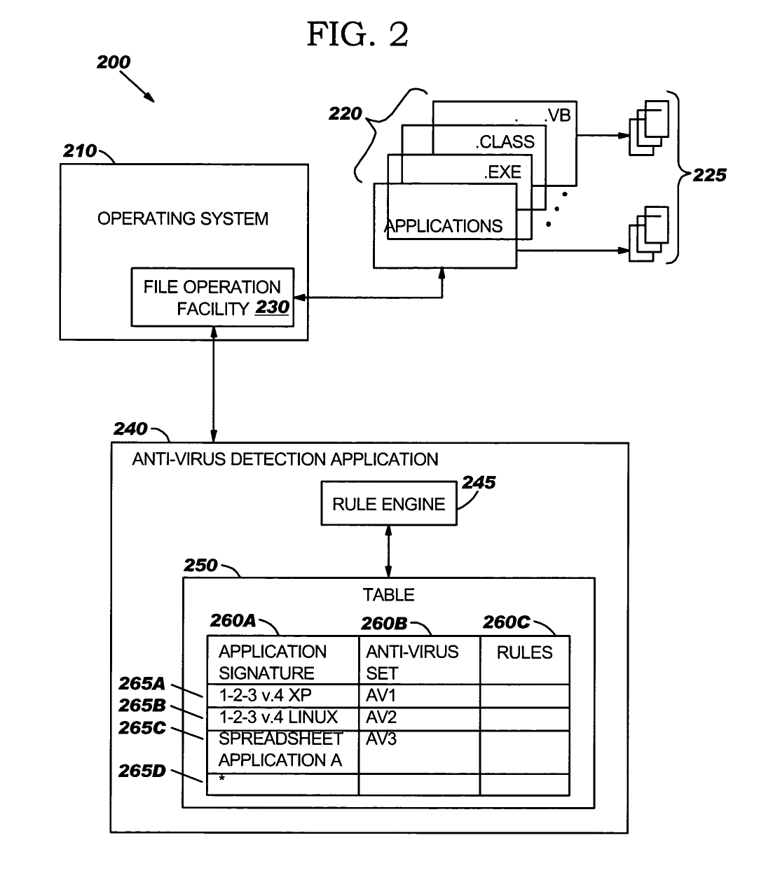

FIG. 2 shows a block diagram illustrating exemplary software functional components which may suitably be employed in a computer system described in FIG. 1 in accordance with the present invention. Those of ordinary skill in the art will appreciate that the operation of the instructions employed in software applications 220, operating system 210, and anti-virus detection application 240 are performed by a processor, such as processor 110 of FIG. 1. It should be recognized by those of ordinary skill in the art that many embodiments of the present invention are possible and for the purpose of explanation the example depicted in FIG. 2 is shown without limiting the scope of the present invention.

The computer system 200 includes one or more software applications 220, an operating system 210 having file operation facilities 230, and an anti-virus detection application 240 having an associative table 250. Software applications 220 represent custom software applications and off-the-shelf software such as Lotus 1-2-3®, Freelance® Graphics, Microsoft® Word, or the like. Files 225 are created or readable by operating software applications 220. Files 225 may have been created by computer system 200, or by another computer system which then communicated them to the computer system 200 through a local area network, Internet network, or the like. Computer viruses may be carried in software applications 220, also known as executing agents, or files 225, also known as target files. Operating system 210 may be commercially available as described in connection with the description of FIG. 1. Alternatively, the operating system 210 may include a Java™ Virtual Machine, or other like interpretive software component. The file operation facility 230 controls file management of files within computer system 200 by receiving requests for file operations and then servicing those requests on hardware devices such as a disk, tape, CD ROM, LAN adapter, or the like. For example, whenever a software application 220 needs to open, create, delete, read, or write a file, the software application 220 makes its request to the file operation facility 230. Upon receiving a request, the file operation facility 230 opens the file on the associated hardware device.

The anti-virus detection application 240 has a rule engine 245 and an associative table 250 for storing and assigning rules and anti-virus sets to executing agents. In the example shown in FIG. 2, the associative table 250 has at least three columns 260A-C and rows 265A-D representing records in the table 250. Column 260A includes known executing agents which may be installed in computer system 200. For example, 1-2-3 version 4 for Windows® XP has been entered in a field at row 265, column 260A, 1-2-3 version 4 for Linux® has been entered in a field at row 265B, column 260B, spreadsheet application A has been entered in a field at row 265C, column 260A, and wildcard “*” has been entered in a field at row 265D, column 260A.

As shown in FIG. 2, table 250 may have different entries for different versions of the same application on different operating systems such as 1-2-3® for XP and 1-2-3® for Linux® allowing the anti-virus application to scan applications based on the operating environment in which the executing agent is run. Although not shown, table 250 allows different entries for different versions of the same application to be assigned for different sets of virus signatures. This assignment mechanism allows an anti-virus application in accordance with the present invention to preclude scanning target files by virus signatures exploiting the old exposure when the target files are opened by a later version executing agent which has fixed exposures found in a previous version.

The field entries in column 260A may be automatically populated by the anti-virus detection application 240 by known techniques such as scouring the disk drive to determine what applications have been installed on computer system 200. In the Windows® operating environment, for example, the Windows® registry may be scanned for the existence of installed applications. In particular, well known applications have published signatures signifying the application name, version, and the like to allow table 250 to be populated without user interaction by scanning the disk drive, registry, or the like for these published signatures. Additionally, application entries may automatically populate field entries in column 260A when the application is installed or upon the execution of the application. Likewise, the anti-virus application 240 allows a user having appropriate authority to modify entries and to add additional records to the table 250.

Column 260B includes the name of the anti-virus set containing one or more virus signatures to be applied in a manner defined by one or more rules specified in column 260C. Column 260C optionally includes one or more rules which drive rule engine 245 to indicate how and when the associated anti-virus sets should be applied. For example, one rule may include a directive to always scan a target file by applying the virus signatures found in the anti-virus set for an executing agent whenever the executing agent listed in column 260A opens a target file. Another rule may describe the manner in which the scanning will take place. For example, rather than triggering virus scanning on a file open, a periodic manner may be specified which would cause the scanning of computer system's 200 file system for all target files associated with a specific executing agent.

Other rules may specify the scope of coverage of associating virus signatures. Considering that files typically contain a unique file identifier which are assigned at creation by an operating system, a rule may specify file identifiers of target files to exclude or include when applying the assigned anti-virus set. By way of another example, a rule may be specified to track target files which have been scanned previously to preclude redundant scanning.

Referring back to the wild card entry at row 265D, column 260A, supporting wildcard entries allow the present invention to tailor virus scanning against unlisted or unknown applications. As with known wildcard matching, combinations of characters are matched against wild cards to determine a match. For example, an entry “*” would match any executing agent which is not listed in column 260A while an entry “Word*” would match all Word applications independent of version or operating environment. Such an approach provides a means to tailor virus scanning on viruses which are carried by executing agents.

Many known techniques exist which describe how a typical anti-virus application may connect to an operating system. One known technique, for example, includes triggering the operation of the anti-virus detection application 240 whenever the file operation facility 230 issues a file open instruction on a target file. For example, whenever the operating system is called to issue a function to open a file, such as an fopen( ) function call, the anti-virus detection application 240 is called by the operating system before any read or write requests are made by software applications 220. Once triggered, the anti-virus detection application 240 may apply different anti-virus sets as listed in column 260B before returning context to the fopen( ) function.

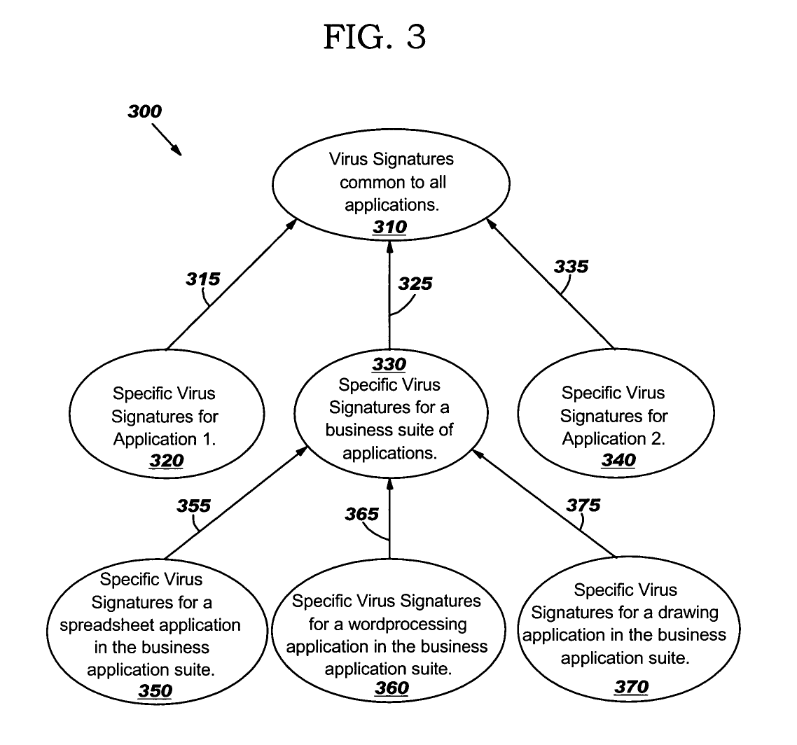

Whenever the instructions of an executing agent begin to execute, the operating system instantiates a running process in which to run the executing agent. The running process contains an application signature as described in column 260 which is associated with the executing agent. In operation, the present invention compares the application signature found in the running process against the entries in column 260A to determine if there is a match to a particular row of table 250. If there is a match, subsequent target files associated with the matched executing agent would be scanned according to all virus signatures found in the anti-virus set entered in column 260B. The level and scope of scanning as described below in connection with the discussion of FIG. 3 may be specified as rules in column 260C.

If column 260C is empty, the anti-virus detection application 240 scans the target file with all the virus signatures stored in the anti-virus set displayed in column 260B. If there are one or more rules in 260C, the one or more rules listed in column 260C are evaluated and applied by the rule engine 245.

Different embodiments exist for the associative table 250. The associative table 250 may be embodied as a file, as a database, or the like. Further, the entries in column 260B show the assignment of anti-virus sets AV1, AV2, and AV3, for example. These anti-virus sets may be implemented as computer files or, in a preferred embodiment, organized within a database. The present invention would typically provide a default for the entries of associative table 250. However, a user may modify the associative table 250 by using a graphical user interface or a file edit utility, if the embodiment of the table is a computer file.

FIG. 3 shows an exemplary database relationship diagram 300 for partitioning virus signatures in accordance with the present invention. In FIG. 3, the database relationship diagram 300 shows three levels of arrangement. The first level contains virus signature set 310. The second level contains virus signature sets 320, 330, 340. The third level contains virus signature sets 350, 360, and 370. Each virus signature found in a set shares a common characteristic with all the other virus signatures found in the same set. This characteristic is described further below. It is noted that additional levels of arrangement and additional sets per level are possible. FIG. 3 is intended as an illustrative example, and not intended to limit the scope of the present invention.

Set 310 contains the set of all common virus signatures which exploit a common exposure found in all executing agents. Set 320 contains the set of all virus signatures of the viruses which exploit only exposures found in Application 1. If, for example, set 320 was assigned to Application 1 in associative table 250, the relevant virus signatures needed to scan target files accessed by Application 1 would include those found in set 320 in addition to those signatures found in set 310, virus signatures common to all applications. This relationship between sets 320 and 310 is established by a link 315. Set 330 contains the set of common virus signatures which exploit only exposures found across a particular suite of business applications. Set 330 references set 310 through link 325 to allow virus signatures common to all applications in addition to virus signatures common to the suite of business applications to be applied, if set 330 was assigned to an application in associative table 250, for example. Set 340 contains the set of all virus signatures which exploit only exposures found in Application 2 and references set 310 through link 335. Set 350 contains the set of all virus signatures which exploit only exposures found in a spreadsheet application typically packaged in the business application suite and references set 330 through link 355. Set 360 contains the set of all virus signatures which exploit only exposures found in a word processing application typically packaged in the business application suite and references set 330 through link 365. Set 370 contains the set of all virus signatures which exploit only exposures found in a drawing application typically packaged in the business application suite and references set 330 through link 375.

Typically, the size of the sets decreases as one goes down the hierarchy such that the number of virus signatures in set 310 would be less than the number of virus signatures in set 330 and the number of virus signatures in set 330 would be less than the number of virus signatures in set 360.

By way of example, an entry in an associative table such as table 250 for spreadsheet application A would include an indication to reference set 350. During operation of the present invention, whenever a spreadsheet was opened or written to the file system, the spreadsheet would be scanned against the virus signatures stored in set 350, the virus signatures stored in set 330, and the virus signatures stored in set 310. If, for example, set 330 was assigned to a drawing application, only the virus signatures in sets 330 and 310 would be utilized. Arranging the sets of virus signatures into a hierarchy provides for efficient memory utilization by precluding the specification of redundant anti-virus sets. This arrangement also allows varying scope of coverage by assigning a set of interest from a specific level. For example, a user may only want to apply virus signatures common across a business suite of applications to the application typically packaged in the business application suite. In that case, the user would assign set 330 into column 260 to the records containing, for example, a drawing application signature and a word processing signature. A fourth level, not shown, may be provided to include different versions of a word processing application, for example. Adding the fourth level, would let a user to specify virus signatures common to all versions of the word processing application or all versions of the word processing application in addition to virus signatures specific to a particular version. It is noted that the term “user” as used herein includes but is not limited to an end user of an executing agent, an information technology specialists, a network administrator, and the like.

It is noted that links 315,325,335,355,365, and 375 maybe bidirectional to allow a user to specify a particular set, 330 for example, to an executing agent and have the virus signatures in sets descending from set 330 be applied to target files of the executing agent. That operation is another example of what may be accomplished by the rules specified in column 260C. It should also be recognize by one of ordinary skill in the art that there are many embodiments of organizing the virus signature sets into a hierarchy and that the exemplary organization depicted in FIG. 3 is not intended to limit the scope of the present invention.

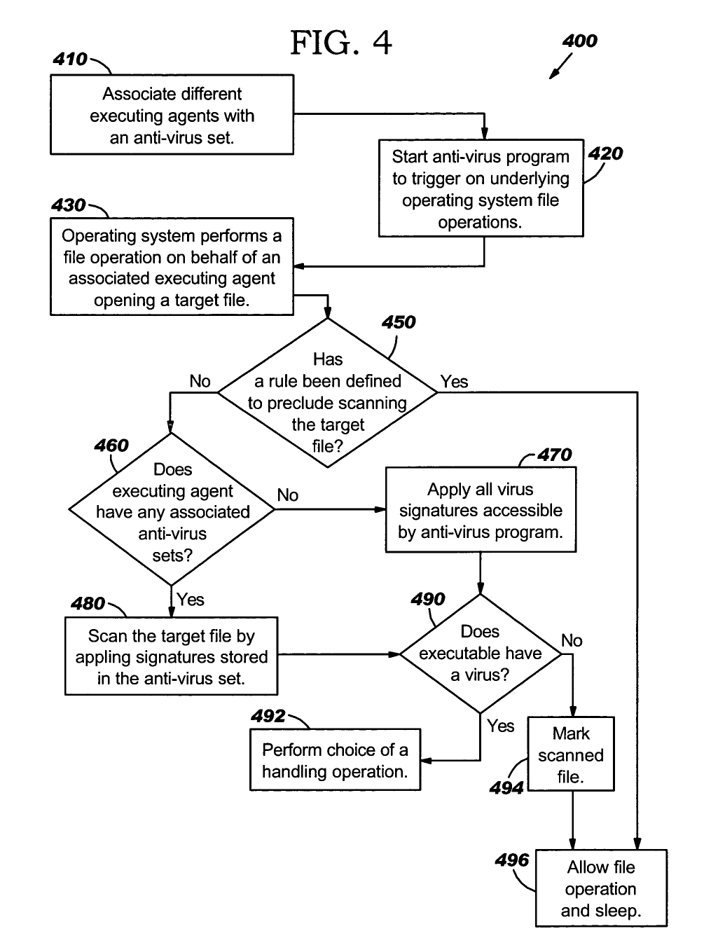

FIG. 4 shows a flowchart 400 illustrating a method of detecting computer viruses in accordance with the present invention. At step 410, an association is made between different executing agents and an anti-virus set. This association may be preassigned or modified by a user. At step 420, the present invention is configured to trigger a scanning operation based upon file operations executing under the context of an operating system or an interpreter. Other known triggering techniques are available and are applicable as well. At step 430, when the operating system attempts to perform a file operation on a target file on behalf of an associated executing agent, the present invention intercepts the file operation in order to execute instructions in accordance with the present invention. Although this realtime scan technique attempts to detect a virus immediately whenever a new file has been opened, other techniques such as a periodic batch scan may be employed in accordance with the present invention. A batch scan may be embodied on a per executing agent basis by entering a periodic batch scan rule into column 260C for a desired executing agent.

At optional step 450, the present invention checks whether a rule has been defined to preclude scanning the target file. For example, one rule may operate to not re-scan target files that have already been scanned. If there is a rule defined to preclude scanning the target file, step 496 is entered where the present invention allows the file operation to continue and the present invention sleeps. If there is no rule defined to preclude scanning, the present invention proceeds to step 460. At step 460, the present invention determines whether the executing agent has any associated anti-virus sets. If there are no associated anti-virus sets, step 470 is entered where an optional default behavior is provided. For example, the target file and executing agent are scanned against all stored anti-virus sets. If there is an associated set, the present invention proceeds to step 480 where the target file is scanned against the virus signatures stored in the anti-virus sets. It is noted that the manner in which a target file is scanned against a specific virus signature is well known by one of ordinary skill in the art. The results of scanning steps 470 and 480 are analyzed at step 490. Step 490 determines if the previous scan found an embedded virus. If there are no embedded viruses, the present invention proceeds to optional step 494. At step 494 the target file is marked to indicate that the file has been successfully scanned before proceeding to step 496. If at step 490 an embedded virus is found in the target file, the present invention proceeds to step 492. At step 492, various recovery operations may be performed with respect to the target file. A user may be notified and options may be provide to the user. Such recovery options include quarantining or deleting the infected file.

It should be understood that although in the preferred embodiment of the invention the anti-virus application is implemented in software, in other embodiments of the invention all or portions of the instruction steps executed by software portion may be resident in firmware or in other program media in connection with one or more computers, which are operative to communicate with the computer system operating on a target file.

The description of the present invention has been presented for purposes of illustration and description, and is not intended to be exhaustive or as limiting the invention in the form disclosed. Many modifications and variations will be apparent to those of ordinary skill in the art. The embodiment was chosen and described in order to best explain the principles of the invention, their practical application, and to enable others of ordinary skill in the art to understand the invention. Subject to the limitations of the claims, various embodiments with various modifications as necessary to adapt the present invention to a particular environment or use are hereby contemplated, including without limitation the adaptation of various teachings herein in light of rapidly evolving hardware and software components and techniques.

1. A computer-readable medium whose contents cause a computer system to perform selective virus signature scanning against a target file associated with an executing agent, the computer system having an anti-virus program with instructions to perform the steps of:
organizing virus signatures into a plurality of anti-virus sets where each set contains a characteristic shared by all the virus signatures within the set;
associating a portion of the plurality of anti-virus sets with the executing agent; and
scanning the contents of the target file for a virus signature which matches a virus signature stored in the associated one or more anti-virus sets.

2. The computer-readable medium of claim 1 further comprising a step before the scanning step, the step comprising:
associating a rule with the executing agent to indicate a manner in which the associated portion of the plurality of anti-virus sets are applied.

3. The computer-readable medium of claim 1 wherein the associating step includes providing user selectable options.

4. The computer-readable medium of claim 2 wherein the rule applied includes a periodic batch scan of one or more target files.

5. The computer-readable medium of claim 2 wherein the manner in which the associated portion of the plurality of anti-virus sets are applied to executing agent's target files includes a trigger mechanism which invokes subsequent scanning of the executing agent's target files.

6. The computer-readable medium of claim 5 wherein the trigger mechanism includes applying the scanning step upon a request for a file operation on the target file.

7. The computer-readable medium of claim 5 wherein the trigger mechanism includes applying the scanning step periodically on one or more target files associated with the executing agent.

8. The computer-readable medium of claim 1 further comprising a step before the organizing step, the step comprising:
determining the plurality of executing agents installed on the computer system.

9. The computer-readable medium of claim 1 wherein the plurality of anti-virus sets have a first anti-virus set and a second anti-virus set, the organizing step further comprises:
arranging the plurality of anti-virus sets into a hierarchical structure having first and second levels, the first level having the first anti-virus set containing virus signatures which are mutually applicable to a plurality of executing agents, the second level having the second anti-virus set containing virus signatures which are exclusively applicable to the first portion of the plurality of executing agents.

10. The computer-readable medium of claim 1
wherein the plurality of anti-virus sets have a first anti-virus set, a second anti-virus set, and a third anti-virus set,
wherein the plurality of executing agents has a first portion,
wherein the organizing step further comprises:
arranging the plurality of anti-virus sets into a hierarchical structure having a first level, a second level, and a third level, the first level having the first anti-virus set containing virus signatures which are mutually applicable to a plurality of executing agents, the second level having the second anti-virus set containing virus signatures which are mutually applicable to the first portion of the plurality of executing agents, the third level having the third anti-virus set containing virus signatures which are exclusively applicable to one of the first portion of the plurality of executing agents.

11. A computer system for performing selective virus signature scanning against a target file associated with an executing agent, the computer system having an anti-virus program comprising:
means for organizing virus signatures into a plurality of anti-virus sets where each set contains a characteristic shared by all the virus signatures within the set;
means for associating a portion of the plurality of anti-virus sets with the executing agent; and
means for scanning the contents of the target file for a virus signature which matches a virus signature stored in the associated one or more anti-virus sets.

12. The computer system of claim 11 further comprising:
means for associating a rule with the executing agent to indicate a manner in which the associated portion of the plurality of anti-virus sets are applied.

13. The computer system of claim 12 wherein the rule includes a periodic batch scan of one or more target files.

14. The computer system of claim 12 wherein the manner in which the associated portion of the plurality of anti-virus sets are applied to executing agent's target files includes a trigger mechanism for activating the means for scanning.

15. The computer system of claim 14 wherein the trigger mechanism includes activating the means for scanning step upon a request for a file operation on the target file.

16. The computer system of claim 14 wherein the trigger mechanism includes applying the scanning step periodically on one or more target files associated with the executing agent.

17. The computer system of claim 11 further comprising:
means for determining the plurality of executing agents installed on the computer system.

18. The computer system of claim 11 wherein the plurality of anti-virus sets have a first anti-virus set and a second anti-virus set, the means for organizing further comprises:
means for arranging the plurality of anti-virus sets into a hierarchical structure having first and second levels, the first level having the first anti-virus set containing virus signatures which are mutually applicable to a plurality of executing agents, the second level having the second anti-virus set containing virus signatures which are exclusively applicable to the first portion of the plurality of executing agents.

19. The computer system of claim 11
wherein the plurality of anti-virus sets have a first anti-virus set, a second anti-virus set, and a third anti-virus set,
wherein the plurality of executing agents has a first portion,
wherein the, means for organizing further comprises:
means for arranging the plurality of anti-virus sets into a hierarchical structure having a first level, a second level, and a third level, the first level having the first anti-virus set containing virus signatures which are mutually applicable to a plurality of executing agents, the second level having the second anti-virus set containing virus signatures which are mutually applicable to the first portion of the plurality of executing agents, the third level having the third anti-virus set containing virus signatures which are exclusively applicable to one of the first portion of the plurality of executing agents.

20. A method for performing selective virus signature scanning against a target file associated with an executing agent comprising:
organizing virus signatures into a plurality of anti-virus sets where each set contains a characteristic shared by all the virus signatures within the set;
associating a portion of the plurality of anti-virus sets with the executing agent; and
scanning the contents of the target file for a virus signature which matches a virus signature stored in the associated one or more anti-virus sets.

21. The method of claim 20 further comprising a step before the scanning step, the step comprising:
associating a rule with the executing agent to indicate a manner in which the associated portion of the plurality of anti-virus sets are applied.

22. The method of claim 21 wherein the rule includes a periodic batch scan of one or more target files.

23. The method of claim 20 wherein the associating step includes providing user selectable options.

24. The method of claim 21 wherein the manner in which the associated portion of the plurality of anti-virus sets are applied to executing agent's target files includes a trigger mechanism for subsequent scanning of the executing agent's target files.

25. The method of claim 24 wherein the trigger mechanism includes applying the scanning step upon a request for a file operation on the target file.

26. The method of claim 24 wherein the trigger mechanism includes applying the scanning step periodically on one or more target files associated with the executing agent.

27. The method of claim 20 further comprising a step before the organizing step, the step comprising:
determining the plurality of executing agents installed on the computer system.

28. The method of claim 20 wherein the plurality of anti-virus sets have a first anti-virus set and a second anti-virus set, the organizing step further comprises:
arranging the plurality of anti-virus sets into a hierarchical structure having first and second levels, the first level having the first anti-virus set containing virus signatures which are mutually applicable to a plurality of executing agents, the second level having the second anti-virus set containing virus signatures which are exclusively applicable to the first portion of the plurality of executing agents.

29. The method of claim 20
wherein the plurality of anti-virus sets have a first anti-virus set, a second anti-virus set, and a third anti-virus set,
wherein the plurality of executing agents has a first portion,
wherein the organizing step further comprises:
arranging the plurality of anti-viral sets into a hierarchical structure having a first level, a second level, and a third level, the first level having the first anti-virus set containing virus signatures which are mutually applicable to a plurality of executing agents, the second level having the second anti-virus set containing virus signatures which are mutually applicable to the first portion of the plurality of executing agents, the third level having the third anti-virus set containing virus signatures which are exclusively applicable to one of the first portion of the plurality of executing agents.
